(19) United States
(12) Patent Application Publication
(10) Pub. No.: US 2015/0292453 A1
(43) Pub. Date: Oct. 15, 2015

(54) SYSTEMS AND METHODS TO REGULATE A PRESSURE IN A FUEL DELIVERY SYSTEM

(71) Applicant: THERMO KING CORPORATION, Minneapolis, MN (US)

(72) Inventors: Keith Michael Ricke, Savage, MN (US); Ross Thomas Nelson, Minneapolis, MN (US)

(21) Appl. No.: 14/648,104

(22) PCT Filed: Nov. 29, 2013
(86) PCT No.: PCT/US2013/072477

§ 371 Date: May 28, 2015

Related U.S. Application Data
(60) Provisional application No. 61/731,747, filed on Nov. 30, 2012.

(51) Int. Cl. F02M 37/00

(52) U.S. Cl. CPC F02M 37/0029; F02M 2037/228

(57) ABSTRACT

Methods and systems to deliver fuel to an engine at a predetermine fuel delivery pressure, such as about zero or a very low fuel pressure, are provided. In some embodiments, a fuel delivery circuit may include a pressure regulating device configured to open a fuel escape path at a predetermined pressure. By providing the fuel escape path, the fuel delivery circuit can maintain a fuel pressure at an outlet of the pressure regulating device at about the predetermined pressure. The fuel delivery circuit may also include a pressure drop device, such as a fuel filter, that requires and causes a pressure drop when fuel flows through the pressure drop device. In some embodiments, the predetermined pressure of the pressure regulating device is about the same as the pressure drop of the pressure drop device. In some embodiments, the pressure regulating device may be integrated inside the pressure drop device.

### FIELD OF TECHNOLOGY

The embodiments disclosed herein relate generally to a fuel delivery system of an engine. More specifically, the embodiments disclosed herein relate to methods and systems that deliver fuel to the engine, for example, at a predetermined pressure.

### BACKGROUND

An internal combustion engine, such as a diesel engine, consumes fuel (e.g. diesel). Some internal combustion engines may have a pressure requirement for the fuel delivered to the engines. For example, one exemplary high pressure common rail (HPCR) diesel engine requires the fuel to be delivered to an engine fuel pump of the HPCR engine at a very low pressure or a slight negative pressure (vacuum) to minimize an impact of the pressure of the incoming fuel on, for example, flow regulation and durability of the HPCR diesel engine.

### SUMMARY

Some engines may have specific pressure requirements for fuel delivered to an engine fuel pump and/or the engine. For example, one exemplary HPCR diesel engine requires fuel to be delivered at about 0 kPa. Methods and systems of delivering fuel at a predetermined pressure, such as for example at about 0 kPa, to the engine are provided herein.

In some embodiments, a method of delivering fuel in a fuel delivery circuit to an engine may include determining a fuel delivery pressure when the fuel delivered to the engine and determining a pressure drop in the fuel delivery circuit. The method may also include providing fuel in the fuel delivery circuit at a regulating pressure, which may be about a sum of the fuel delivery pressure and the pressure drop in the fuel delivery circuit. The method may further include directing at least a portion of the fuel to the engine and providing a fuel escape path configured to open at about the regulating pressure.

In some embodiments, the method may include directing a portion of the fuel through the fuel escape path when the fuel escape path opens. In some embodiments, the fuel delivery circuit may include a fuel filter, and the pressure drop may be about a pressure drop required for the fuel to flow through the fuel filter.

In some embodiments, a fuel delivery circuit may include a pressure regulating device, a pressure drop device, a fuel tank and fuel lines connecting these components. In some embodiments, the pressure regulating device may be configured to provide a fuel escape path that opens at a predetermined pressure.

In some embodiments, the fuel escape path may be configured to direct fuel to a fuel line directing fuel back to the fuel tank. In some embodiments, a value of a fuel pressure at an outlet of the pressure regulating device may be about the same as a value of a pressure drop required for the fuel to flow through the pressure drop device, such as a fuel filter.

In some embodiments, the pressure drop device is a fuel filter. In some embodiments, the pressure regulating device is equipped with a pressure regulating mechanism, such as a check ball valve, an orifice, a needle valve, etc.

In some embodiments, the pressure regulating device may be positioned inside the fuel filter. In some embodiments, the fuel filter may include a filter medium, the fuel escape path may be configured to direct at least a portion of fuel in a lower portion of the fuel filter to a fuel line directing fuel back to the fuel tank.

Other features and aspects of the embodiments will become apparent by consideration of the following detailed description and accompanying drawings.

### BRIEF DESCRIPTION OF THE DRAWINGS

FIG. 1 is a schematic diagram of a fuel delivery circuit configured to deliver fuel to an engine fuel pump of an engine.

FIG. 2 is a schematic diagram of a pressure regulating device equipped with a pressure regulating mechanism.

FIGS. 3A to 3C illustrate three embodiments of a pressure regulating device. FIG. 3A illustrates a pressure regulating device with a check ball valve. FIG. 3B illustrates a pressure regulating device with an orifice. FIG. 3C illustrates a pressure regulating device with a needle valve.

FIG. 4 illustrates a method for delivering fuel to an engine at a predetermined pressure.

FIG. 5 illustrates an embodiment of a fuel delivery circuit equipped with a fuel filter and a pressure regulating device.

FIG. 6 illustrates another embodiment of a fuel delivery circuit equipped with a fuel filter that has an integrated pressure regulating device.

### DETAILED DESCRIPTION

An internal combustion engine consumes fuel, such as diesel fuel. Some internal combustion engines may have a pressure requirement for fuel delivered to the engine, for example, to minimize an impact of the pressure of the incoming fuel on fuel regulation systems of the engines. For example, one exemplary diesel engine with a HPCR system requires the fuel to be delivered to an engine fuel pump of the diesel engine at a relatively low pressure or a slight vacuum to minimize the impact of the fuel pressure on the fuel flow regulation of the diesel engine. Delivering fuel at a relatively low pressure or a slight vacuum may also help increase the service life and/or reliability of a low pressure side of the diesel engine.

In the following description, methods and systems to deliver fuel at a relatively low pressure, about 0 kPa, a negative pressure, or other predetermined fuel delivery pressure(s), to an engine fuel pump of an engine are described. In some embodiments, the system may include a fuel tank, a fuel delivery pump and fuel lines forming a fuel delivery circuit. In some embodiments, the fuel delivery circuit may further include a pressure regulating device positioned in-line with the fuel lines of the fuel delivery circuit. The pressure regulating device can be configured to direct fuel toward a fuel escape path when the pressure of the fuel flowing through the pressure regulating device is above a predetermined fuel pressure. The fuel escape path may be configured to direct fuel flowing through the fuel escape path back to the fuel tank. In some embodiments, the fuel circuit may further include a pressure drop device (e.g. a fuel filter) positioned in-line with the fuel lines. The pressure drop device may generally require and cause a fuel pressure drop when the fuel flows through the pressure drop device. In some embodiments, the fuel circuit may be configured so that the predetermined fuel pressure is within a relatively small range of the fuel pressure drop of the pressure drop device. As a result, the fuel can be delivered to the engine fuel pump at a relatively low pressure or a slight negative pressure by the fuel delivery circuit.

References are made to the accompanying drawings that form a part hereof, and in which is shown by way of illustration of the embodiments in which the embodiments may be practiced. Generally, the words “upstream” and “downstream” are relative to a fuel flow direction. If a first device is positioned upstream of a second device, then the fuel generally reaches the first device before reaching the second device. Conversely, if the first device is positioned downstream of the second device, then the fuel generally reaches the second device first before reaching the first device. The term “in-line” generally means in fluid communication. It is to be understood that the terms used herein are for the purpose of describing the figures and embodiments and should not be regarding as limiting the scope of the present application.

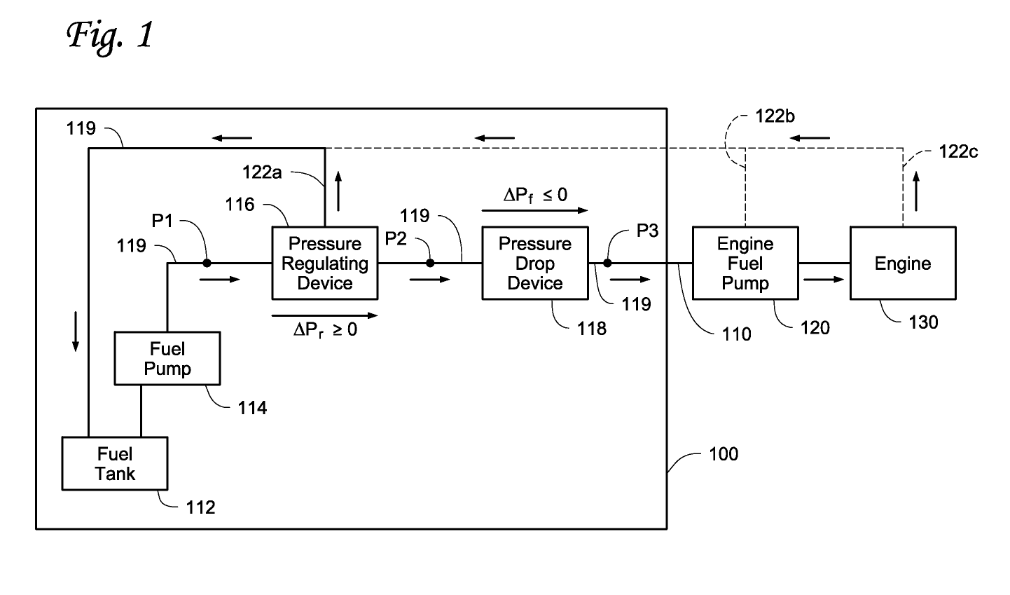

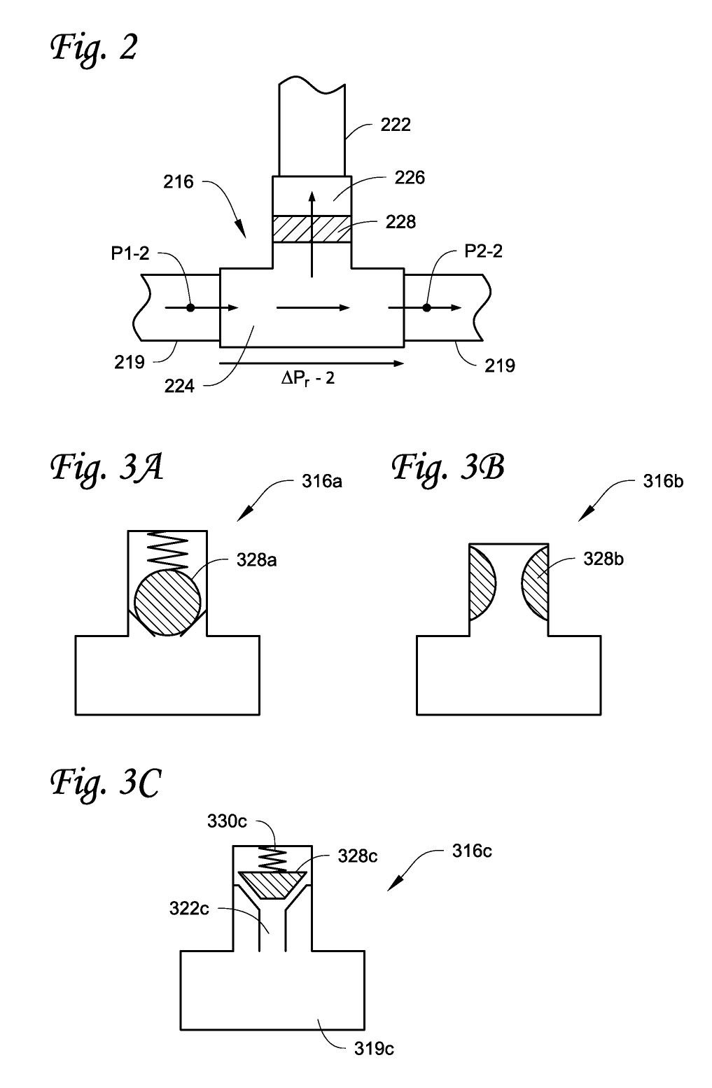

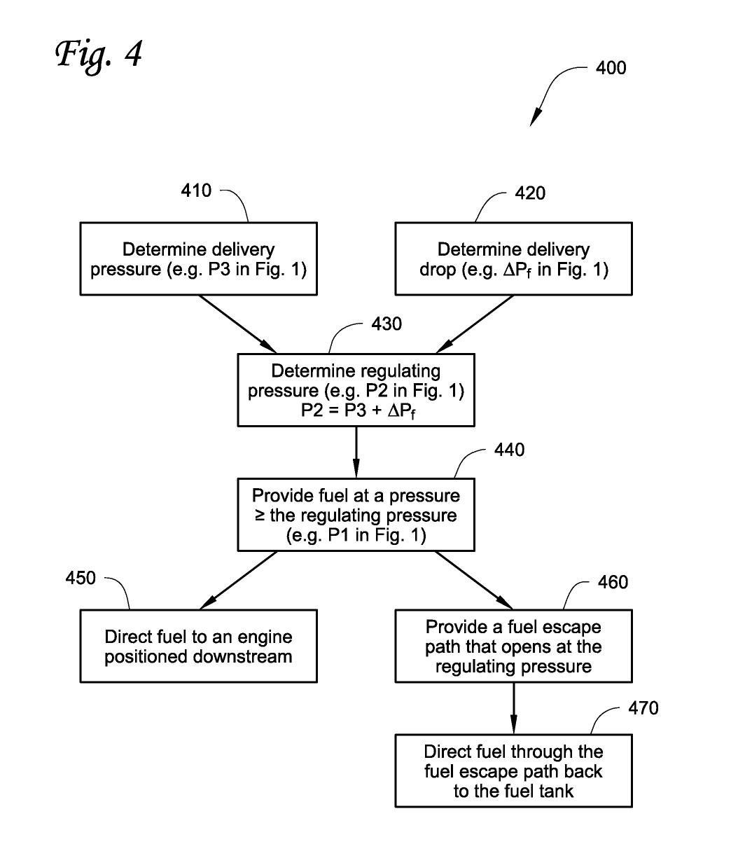

FIG. 1 illustrates a schematic diagram of an embodiment of a fuel delivery circuit 100 configured to regulate a fuel pressure P3 of the fuel delivered at a fuel inlet 110 of an engine fuel pump 120. The fuel delivery circuit 100 includes a fuel tank 112 configured to store fuel, a fuel delivery pump 114 configured to pump fuel out of the fuel tank 112 and through the fuel delivery circuit 100, a pressure regulating device 116, and a pressure drop device 118 (e.g. a fuel filter). The fuel tank 112, the fuel delivery pump 114, the pressure regulating device 116 and the pressure drop device 118 are connected by the fuel lines 119.

As illustrated in FIG. 1, the pressure regulating device 116 is also configured to have a fuel escape path 122a, which provides a flow path to allow fuel to flow out of the pressure regulating device 116, and then flow back to the fuel tank 112. By releasing fuel from the fuel escape path 122a in a pressure controlled manner, a fuel pressure P2 of the fuel flowing through the pressure regulating device 116 can be regulated.

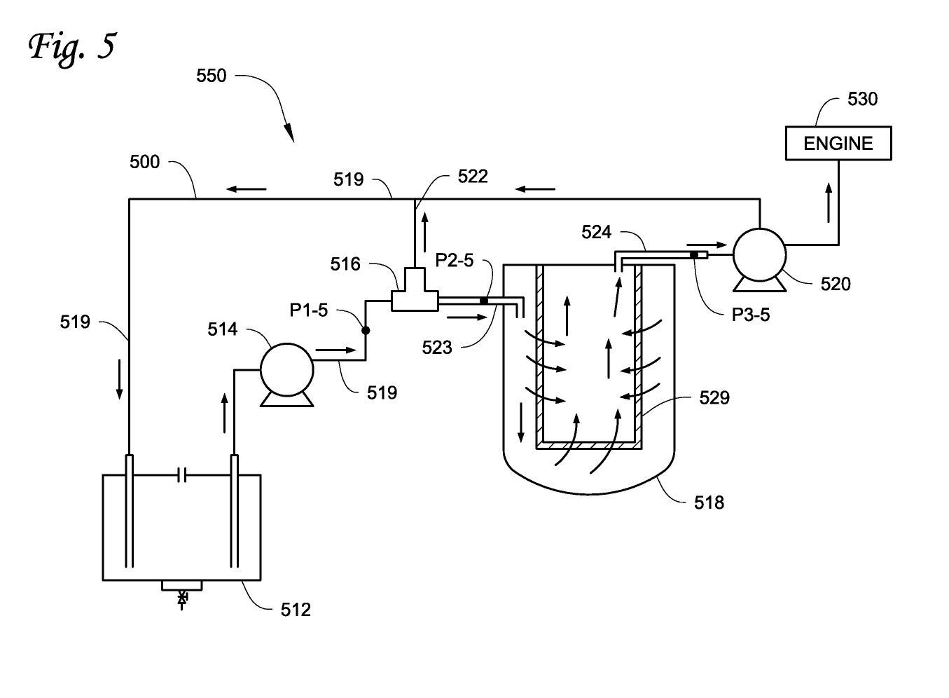

The term “pressure drop device” in this document generally refers to a device that can cause a pressure drop in the fuel pressure when the fuel flows through the device. The pressure drop device 118 can be a fuel filter (e.g. the fuel filter 518 as illustrated in FIG. 5). When the fuel flows through the fuel filter, the pressure drop may be caused by driving the fuel through a filter medium of the fuel filter. It is to be appreciated that the pressure drop device in this document can be any device that requires and/or causes a pressure drop when the fuel flows through the device in the fuel delivery circuit 100, other than the fuel regulating device 116. It is also to be appreciated that the fuel delivery circuit 100 can have more than one pressure drop device. Generally the pressure drop device may be positioned in line with the fuel lines 119.

For the purpose of this document, the term “pressure drop device” generally is not meant to include the pressure regulation device (e.g. the pressure regulating device 116). However, it is to be understood that the pressure regulating device may require and cause some pressure drop in the fuel when the fuel flow through the pressure regulating device.

The term “pressure drop in the fuel delivery system” generally means a sum of the pressure drops caused by circulating the fuel through the fuel delivery system (e.g. the fuel delivery circuit 100), which can be caused, for example, by the fuel lines (e.g. the fuel lines 119), the pressure drop devices, the pressure regulating device, etc. In this document, generally the pressure drop of the pressure drop device (instead of a pressure drop in the fuel delivery system) is used for describing the embodiments. However, it is to be understood the embodiments disclosed herein can be applied with a “pressure drop in the fuel delivery system.”

The fuel delivery circuit 100 is configured to deliver the fuel to the engine fuel pump 120, which is configured to provide the fuel to an engine 130. In some embodiments, the engine fuel pump 120 may have a pressure requirement for the fuel delivered at the inlet 110 of the engine fuel pump 120. In some embodiments, the engine fuel pump 120 may require the fuel to be delivered at about 0 kPa, a very low pressure or a negative pressure, such as from about 0 kPa to about −50 kPa. This pressure requirement for the fuel delivered at the inlet 110 of the engine fuel pump 120 may be set up by a manufacturer of the engine. It is to be appreciated that the fuel delivery circuit 100 can also be configured to deliver the fuel to the engine fuel pump 120 at other predetermined fuel pressures if desired.

In some embodiments, the engine fuel pump 120 and/or the engine 130 can also be optionally equipped with a fuel escape path 122b and 122c respectively. The fuel escape paths 122b and 122c can be configured to direct, for example, excessive fuel of the engine fuel pump 120 and/or the engine 130 back to the fuel tank 112.

Arrows in FIG. 1 indicate directions of a fuel flow when the fuel delivery circuit 100, the engine fuel pump 120 and the engine 130 are in operation. The fuel delivery pump 114 can be configured to pump fuel out of the fuel tank 112.

The fuel pressure in the fuel line 119 out of the fuel delivery pump 114 is P1. The fuel pressure P1 may be regulated by the operation of the fuel delivery pump 114. For example, a faster operation speed of the fuel delivery pump 114 may generally correlate with a higher fuel pressure P1. The fuel pressure P1 may also be affected by a location of the fuel tank 112. Generally, raising the position of the fuel tank 112 relative to a position of the fuel pump 114 may generally correlate with a higher fuel pressure P1.

The fuel delivery circuit 100 is equipped with the pressure regulating device 116, which is positioned in-line with the fuel lines 119 and is positioned downstream of the fuel delivery pump 114. The fuel regulating device 116 can be configured to release some fuel into the fuel escape path 122a so that a fuel pressure P2 can be maintained at a predetermined pressure. In the fuel delivery circuit 100, the fuel pressure P1 is generally configured to be about the same as or higher than the fuel pressure P2, so that a fuel pressure drop ΔPᵣ within the pressure regulating device 116 in a direction of the fuel line 119 is at least 0 (i.e. ΔPᵣ≧0). If the fuel pressure P1 is about the same as the fuel pressure P2, the pressure regulating device may be configured to not release fuel into the fuel escape path 122a. If the fuel pressure P1 is higher than the fuel pressure P2, the pressure regulating device 116 may be configured to direct some fuel to the fuel escape path 122a and be directed back to the fuel tank 112 through the fuel lines 119. Generally, a larger difference between the fuel pressure P1 and the fuel pressure P2 causes a larger amount of fuel to be released to the fuel escape path 122a. By releasing some fuel into the fuel escape path 122a, the pressure P2 can be maintained, for example, at about the predetermined number.

Generally, the pressure drop ΔPᵣ of the pressure regulating device 116 is a changing number. The pressure drop ΔPᵣ may be affected by the amount of the fuel released to the fuel escape path 122a. Generally, the higher the amount of fuel released to the fuel escape path 112a, the higher the pressure drop ΔPᵣ. On the other hand, a higher difference between the fuel pressures P1 and P2 may correlate to a higher amount of fuel released to the fuel escape path 116 and a higher pressure drop ΔPᵣ through the pressure regulating device 116.

Because the pressure regulating device 116 can help maintain the pressure P2 at about the predetermined pressure by releasing variable amount of fuel to the fuel escaping line 122a, the pressure P1 can have a relatively small effect on the pressure P2.

Therefore, the operation of the fuel pump 114 and/or the locations of the fuel tank 112 may have relatively small effect on the pressure P2.

The pressure drop device 118 is a device that may require and/or cause some pressure drop when the fuel passes through. The pressure drop device 118 can be a fuel filter, which can cause a fuel pressure drop ΔP_{f} when the fuel flows through a filter medium of the fuel filter (i.e. ΔP_{f}≦0). The fuel pressure drop ΔP_{f} through the fuel filter may be affected by the configuration of the fuel filter, and/or an in-service time of the fuel filter. Generally, when fuel flows through the fuel filter, impurities in the fuel may gradually clog the filter medium of the fuel filter. Therefore, generally the longer the in-service time of the fuel filter is, the higher the fuel pressure drop of the fuel filter.

The pressure P3 in the fuel line 119 at the downstream side of the pressure drop device 118 is about the fuel pressure P2 minus an absolute value of the pressure drop ΔP_{f} of the pressure drop device 118. Therefore, the pressure P3, which is the fuel pressure of the fuel delivered to the engine fuel pump 120 can be regulated by configuring the fuel pressure P2. Generally, if the pressure drop device 118 is a fuel filter, the pressure P3 may be calculated by using a ΔP_{f} corresponding to a fuel pressure required for the fuel to flow through the fuel filter when the fuel filter is new (or unclogged).

It is to be noted that the delivery circuit 100 as illustrated in FIG. 1 is exemplary. The relative positions of the fuel delivery pump 114, pressure regulating device 116 and/or the pressure drop device 118 along the fuel lines 119 can be changed. For example, the pressure regulating device 116 may be positioned downstream of the pressure drop device 118. However, if the pressure drop device 118 is a fuel filter, it is preferred to position the pressure regulating device 116 upstream of the pressure drop device 118 to prevent the pressure drop device 118 from transmitting or receiving a high fuel pressure.

It is noted that the pressure regulating device may also include a pressure compensated device, a pressure balanced device, a pressure differential device, in the form of a valve, a regulator, a filter, etc.

FIG. 2 illustrates a schematic view of an embodiment of a pressure regulating device 216. The pressure regulating device 216 is configured to have a fuel delivery path 224 positioned in-line with a fuel line 219, and a fuel escape path 226 positioned in-line with a fuel escape path 222. The fuel escape path 226 is configured to have a pressure regulating mechanism 228 positioned in-line with the fuel escape path 226, with the notion that the pressure regulating mechanism 228 can also be positioned in-line with the fuel delivery path 224.

The pressure regulating mechanism 228 is configured to allow fuel to flow through when for example a fuel pressure P1-2 and/or a fuel pressure P2-2 is above a predetermined pressure. When the pressure P1-2 and/or the fuel pressure P2-2 of the fuel exiting the pressure regulating device 216 reach or exceed the predetermined pressure, the pressure regulating mechanism 228 can be opened to release fuel to the fuel escape path 226, so that the fuel pressure P2-2 can be maintained at about the predetermined pressure. In some embodiments, the pressure regulating mechanism 228 may be a direct acting relief valve, a check valve, a differential pressure operated flow valve, a pressure compensated flow regulator or valve, a needle valve, etc.

Generally, the fuel delivery path 224 is configured to direct the fuel toward an engine (e.g. the engine 130 in FIG. 1) or an engine fuel pump (e.g. the engine fuel pump 120). The fuel escape path 226 is configured to be in fluid communication with a fuel line that is configured to direct the fuel back to a fuel tank (e.g. the fuel tank 112 in FIG. 1).

FIGS. 3A to 3C illustrate three exemplary embodiments of pressure regulating devices 316a, 316b and 316c, which can be used as the pressure regulating device 116 as illustrated in FIG. 1. In FIG. 3A, a check ball valve 328a functions as a pressure regulating mechanism, which is configured to open at a predetermined pressure of the fuel.

In FIG. 3B, a flow restriction mechanism, such as an orifice 328b functions as a pressure regulating device, which is configured to allow the fuel to flow through when the pressure of the fuel is above a predetermined pressure.

FIG. 3C illustrates another embodiment of a pressure regulating device 316c, which includes a needle 328c and a fuel escape path 322c. The needle 328c can close the fuel escape path 322c when there is no fuel flowing through a fuel line 319c of the pressure regulating device 316c. When there is a fuel flow through the fuel line 319c, the needle 328c can open the fuel escape path 322c when the fuel is at or above a predetermined pressure. The pressure required to open the fuel escape path 322c can be affected by, for example, a weight of the needle 328 and/or characteristics of a spring 330c. In some embodiments, the pressure regulating device 316c may not have the spring 330c. In some embodiments, the needle 328c can close the fuel escape path 322c by its own weight.

It is to be appreciated that other suitable pressure regulating devices can also be used.

FIG. 4 illustrates a method 400 to deliver fuel to an engine fuel pump (e.g. the engine fuel pump 120 in FIG. 1) at a predetermined fuel delivery pressure (e.g. the fuel pressure P3 in FIG. 1) in a fuel delivery circuit (such as the fuel delivery circuit 100 in FIG. 1), at for example a very low, zero, or a slight negative pressure. At 410, the delivery pressure is determined. The delivery pressure can be determined, for example, based on a requirement provided by a manufacturer. The delivery pressure may be determined, for example, provided as specifications of an engine (the engine 130 in FIG. 1) and or an engine fuel pump (e.g. the engine fuel pump 120 in FIG. 1), to which the fuel is delivered. It is to be noted that the delivery pressure can be configured to other values to satisfy different considerations.

At 420, a pressure drop of a pressure drop device (e.g. the pressure drop device 118 in FIG. 1) of the fuel delivery circuit is determined. The pressure drop of the delivery circuit may include the pressure drop (e.g. ΔP_{f} in FIG. 1) of the pressure drop device, as well as pressure drops caused by other devices and/or fuel lines of the fuel delivery circuit other than a pressure regulating device (e.g. the pressure regulating device 116 in FIG. 1). The pressure drops of the devices in the fuel delivery circuit may be, for example, provided by the manufacturers of the devices, or measured in a laboratory setting.

In some embodiments, the pressure drop device may be a fuel filter. In some embodiments, the pressure drop at 420 can be about a pressure required for the fuel to flow through the fuel filter when the fuel filter is new or unclogged.

At 430, a regulating pressure (e.g. the fuel pressure P2 in FIG. 1) is determined. In some embodiments, the regulating pressure is generally configured to be about a sum of the delivery pressure determined at 410 and the pressure drop of the fuel delivery circuit determined at 420. It is to be appreciated that the regulating pressure can be other values.

At 440, fuel with a pressure that is about equal to or above the regulating pressure determined at 430 is provided, for example, by a fuel delivery pump, such as the fuel delivery pump 114 in FIG. 1. Fuel with a pressure may, for example, also be provided by positioning a fuel tank (e.g. the fuel tank 112 in FIG. 1) at a relatively high position relative to a position of the fuel delivery pump, (e.g. positioning the fuel tank higher than a location of the engine delivery pump 120 in FIG. 1).

At 450, at least a portion of the fuel is directed to an engine (e.g. the engine 130 in FIG. 1) and/or an engine fuel pump (e.g. the engine fuel pump 120 in FIG. 1). The portion of the fuel directed to the engine may depend on an operational fuel requirement of the engine.

At 460, a fuel escape path is configured to be open when the fuel pressure is about or above the regulating pressure determined at 430. By opening the fuel escape path at about or above the regulating pressure, the fuel delivery pressure to the engine and/or the engine fuel pump can be maintained at about the delivery pressure determined at 410. At 470, fuel flowing through the fuel escape path can be directed back to the fuel tank.

In some embodiments, when the fuel delivery pressure needs to be relatively low, about zero or slight negative, the regulating pressure may be configured to be about equal to the pressure drop of the fuel delivery system. In some embodiments, the pressure drop of the fuel delivery system may be mainly due to a fuel filter, the regulating pressure may be configured to be about the same as the pressure required for the fuel to flow through a filter medium of the fuel filter.

FIG. 5 illustrates another embodiment of a fuel system 550 that includes a fuel delivery circuit 500 that is configured to deliver fuel to an engine fuel pump 520. In this embodiment, a fuel filter 518 is configured to function as a pressure drop device (e.g. the pressure drop device 118 in FIG. 1). The fuel delivery circuit 500 includes components such as a fuel tank 512, a fuel delivery pump 514, a pressure regulating device 516, the fuel filter 518 and fuel lines 519 connecting the components of the fuel delivery circuit 500. The pressure regulating device 516 is configured to have a fuel escape path 522 directing fuel flowing through the fuel escape path 522 back to the fuel tank 512.

The fuel filter 518 includes a filter medium 529 that is configured to filter fuel delivered to the engine fuel pump 520. The fuel filter 518 and the pressure regulating device 516 are generally two separate devices in the fuel delivery circuit 500.

In operation, the fuel delivery pump 514 is configured to pump the fuel through the fuel delivery lines 519. When the fuel leaves the fuel delivery pump 514, the fuel has a pressure P1-5. The fuel then flows into the fuel regulating device 516, which is configured to maintain a fuel pressure P2-5 at an outlet 523 of the pressure regulating device 516 at, for example, a predetermined fuel pressure. The predetermined fuel pressure may be about the same as the sum of the fuel delivery pressure requirement at the engine fuel pump 520 and a pressure drop caused by the fuel filter 518, with the appreciation that the pressure regulation device 516 can be configured to maintain the fuel pressure P2-5 at other pressures. Generally, the pressure P1-5 is about the same as or above the predetermined fuel pressure. The fuel regulating device 516 is configured to release some fuel through the fuel escape path 522 so as to maintain the fuel pressure P2-5 at the outlet 523 of the pressure regulating device 516 at the predetermined fuel pressure.

The fuel is then directed through the fuel filter 518. The filter medium 529 is configured to cause a certain degree of fuel pressure drop for the fuel passing through the filter medium 529. As a result, a pressure P3-5 at a filter outlet 524 is reduced by about the pressure drop caused by the filter medium 529 from the pressure P2-5.

In some embodiments, for example, when it is required to deliver the fuel to the engine fuel pump 520 at a relatively low pressure, about 0 kPa and/or a slight negative pressure (for example, when the pressure drop caused by the filter medium 529 being higher than the fuel pressure P2-5), the fuel pressure P2-5 can be configured to be about the same as the pressure drop caused by the filter medium 529. When the filter medium 529 has been in service for a period of time, impurities from the fuel can accumulate on and clog the filter medium 529, causing a slightly increased fuel pressure drop across the filter medium 529. The engine fuel pump 520 can operate to provide a vacuum in the fuel lines 519 to help direct the fuel through the filter medium and toward the engine fuel pump 520 and/or an engine 530.

Providing the fuel escape path 522 can help maintain the pressure P2-5 at the predetermined value. The fuel pressure P1-5 can be affected by operations of the fuel delivery pump 514 and locations of the fuel tank 512. For example, generally the higher the fuel tank 512 is located relative to the fuel pump 514, the higher the fuel pressure P1-5. Since providing the fuel escape path 522 can help maintain thee fuel pressure P2-5, the fuel tank 512 can be located at various height locations without significantly affecting the fuel pressure P2-5. It is also to be noted that since the fuel pressure P2-5 can be maintained relatively constant by the pressure regulating device 516, variations in the operation of the fuel pump 514 may not have significant effect on the fuel pressure P2-5. Therefore, the operations of the fuel pump 514 may not be critical for regulating the fuel pressure P2-5.

In some embodiments, the fuel filter 518 may include a drainage (not shown) at, for example, a bottom of the fuel filter 518. The drainage can allow liquid (e.g. water) to be drained from the fuel filter 518. In some embodiments, the drainage can be connected to the fuel tank 512, so that the drained liquid can be directed back to the fuel tank 512.

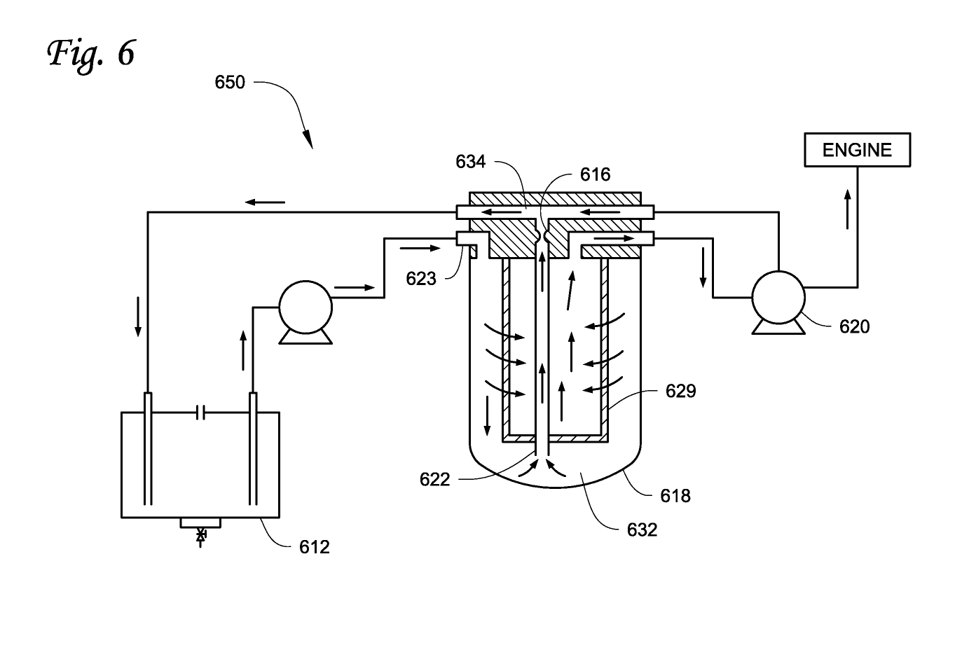

In some embodiments, a fuel filter can be configured to incorporate a pressure regulating device within the fuel filter of a fuel system. FIG. 6 illustrates another embodiment of a fuel delivery system 650 that includes a fuel filter 618 having an integrated pressure regulating device 616 and a filter medium 629. A fuel escape path 622 is configured to form a fuel escape path from a lower region 632 of the fuel filter 618 to a fuel return line 634 of the fuel filter 618. The fuel return line 634 is configured to direct the fuel back to a fuel tank 612. The fuel filter 618 is configured to filter the fuel to be delivered to an engine fuel pump 620. Some fuel from the engine fuel pump 620 can also be directed into the fuel return line 634.

In operation, the fuel from the fuel tank 612 is directed into the fuel filter 618 through a filter inlet 623. At least a portion of the fuel entering the fuel filter 618 flows through the filter medium 629 and is directed toward the engine fuel pump 620 to, for example, satisfy an operational fuel requirement of the engine.

As illustrated in FIG. 6, the pressure regulating device 616 can be an orifice. It is to be appreciated that other pressure regulation configurations, such as illustrated in FIG. 3A to 3C, can also be used as the pressure regulation device 616. The pressure regulation device 616 can be configured to create a predetermined fuel pressure inside the fuel filter 618 to help fuel flow through the filter medium 629. In some embodiments that require the fuel to be delivered at a relatively low pressure, about 0 kPa or a slight negative pressure to the engine fuel pump 620, the predetermined fuel pressure can be configured to be about a pressure required for the fuel to flow through the filter medium 629 when the fuel filter 618 is new or unclogged.

Some fuel can be directed into the fuel escape path 622. Because the fuel escape path 622 is configured to extend into the lower portion 632 of the fuel filter 618, which contains the unfiltered fuel, the fuel escape path 622 can also direct water and/or impurities accumulated in the lower portion 632 of the fuel filter 618 back to the fuel return line 634, and then back to the fuel tank 612. Directing water and the impurities out of the fuel filter 618 can help extend the service life span of the fuel filter 618.

In operation, the fuel filter 618 may be warmed up by receiving hot fuel. Allowing hot fuel and water to escape through the fuel escape path 622 may help the engine to start up quickly. The hot fuel may also help to melt gelled fuel quicker during engine start up.

It is to be appreciated that the embodiments as disclosed herein may be used with various fuel filter designs. In the illustrated embodiments as shown in FIGS. 5 and 6, the fuel filter is configured to filter the fuel from external of the filter to the internal of the filter. In some embodiments, the fuel filter may be configured to filter the fuel from internal of the filter to the external of the filter. In some embodiments, the fuel filter may include an oil drainage line that can allow oil filtered by the fuel filter to return to the engine.

### Aspects

Any of aspects 1-3 can be combined with any of aspects 4-15. Any of aspects 4-12 can be combined with any of aspects 13-15.

Aspect 1. A method of delivering fuel in a fuel delivery circuit to an engine comprising:

providing fuel in the fuel delivery circuit at or above a regulating pressure, wherein the regulating pressure is a sum of a fuel delivery pressure and a pressure drop in the fuel delivery circuit;

directing the fuel toward the engine; and directing a first portion of the fuel away from the engine so that a second portion of the fuel directed toward the engine is at the fuel delivery pressure.

Aspect 2. The method of aspect 1, wherein a pressure drop in the fuel delivery circuit is a pressure drop required for the fuel to flow through a fuel filter configured to be positioned upstream of the engine.
Aspect 3. The method of aspects 1-2, wherein the fuel delivery pressure is 0 kPa.
Aspect 4. A fuel delivery system comprising:

a pressure regulating device

a pressure drop device; and

a fuel line connecting the pressure regulating device and the pressure drop device;

wherein the pressure regulating device is configured to provide a fuel escape path, the fuel escape path has an open state and an closed state,

when a pressure of fuel through the pressure regulating device is at or above a predetermined pressure, the fuel escape path is at the open state, and when the pressure of fuel through the pressure regulating device is lower than the predetermined pressure, the fuel escape path is at the closed state; and

the pressure drop device is configured to cause a pressure drop in the fuel when the fuel flows through the pressure drop device.

Aspect 5. The fuel delivery system of aspect 4, wherein the pressure drop device is positioned downstream of the pressure regulating device along the fuel line.
Aspect 6. The fuel delivery system of aspects 4-5, further comprising:

a fuel tank, wherein the fuel escape path is configured to direct the fuel to the fuel tank.

Aspect 7. The fuel delivery system of aspects 4-6, wherein a fuel pressure at an outlet of the pressure regulating device is the same as a pressure drop required for fuel to flow through the pressure drop device.
Aspect 8. The fuel delivery system of aspects 4-7, wherein the pressure drop device is a fuel filter.
Aspect 9. The fuel delivery system of aspects 4-8, wherein the pressure regulating device is equipped with a pressure regulating mechanism, and the pressure regulating mechanism is at least one of a check ball valve, and an orifice.
Aspect 10. The fuel delivery system of aspects 8-9, further comprising:

a fuel tank,

wherein the pressure regulating device is positioned inside the fuel filter, and the fuel escape path of the pressure regulation device is configured to direct fuel in a lower portion of the fuel filter back to the fuel tank.

Aspect 11. The fuel delivery system of aspects 4-10, wherein the pressure regulating device is positioned upstream of the pressure drop device.
Aspect 12. The fuel delivery system of aspects 4-11, further comprising:

an engine fuel pump;

wherein the pressure drop device is positioned upstream of the engine fuel pump.

Aspect 13. A fuel regulation device for a fuel delivery system comprising:

a fuel delivery path; and

a fuel escape path;
wherein the fuel delivery path and the fuel escape path are in fluid communication, the fuel escape path is configured to open when a fuel pressure in the fuel delivery path is at or above a predetermined pressure, the fuel escape path is configured to be closed when a fuel pressure in the fuel delivery path is below the predetermined pressure,
   Aspect 14. The fuel regulation device of aspect 13, wherein the fuel escape path is configured to direct the fuel toward a fuel tank and the fuel delivery path is configured to deliver fuel to an engine.
   Aspect 15. The fuel regulation device of aspects 13-14, wherein the fuel escape path includes at least one of a check valve, and an orifice.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What claimed is:

1. A method of delivering fuel in a fuel delivery circuit to an engine comprising:
providing fuel in the fuel delivery circuit at or above a regulating pressure, wherein the regulating pressure is a sum of a fuel delivery pressure and a pressure drop in the fuel delivery circuit;
directing the fuel toward the engine; and
directing a first portion of the fuel away from the engine so that a second portion of the fuel directed toward the engine is at the fuel delivery pressure.

2. The method of claim 1, wherein a pressure drop in the fuel delivery circuit is a pressure drop required for the fuel to flow through a fuel filter configured to be positioned upstream of the engine.

3. The method of claim 1, wherein the fuel delivery pressure is 0 kPa.

4. A fuel delivery system comprising:
a pressure regulating device a pressure drop device; and
a fuel line connecting the pressure regulating device and the pressure drop device;
wherein the pressure regulating device is configured to provide a fuel escape path, the fuel escape path has an open state and an closed state,
when a pressure of fuel through the pressure regulating device is at or above a predetermined pressure, the fuel escape path is at the open state, and when the pressure of fuel through the pressure regulating device is lower than the predetermined pressure, the fuel escape path is at the closed state; and
the pressure drop device is configured to cause a pressure drop in the fuel when the fuel flows through the pressure drop device.

5. The fuel delivery system of claim 4, wherein the pressure drop device is positioned downstream of the pressure regulating device along the fuel line.

6. The fuel delivery system of claim 4, further comprising:
a fuel tank, wherein the fuel escape path is configured to direct the fuel to the fuel tank.

7. The fuel delivery system of claim 4, wherein a fuel pressure at an outlet of the pressure regulating device is the same as a pressure drop required for fuel to flow through the pressure drop device.

8. The fuel delivery system of claim 4, wherein the pressure drop device is a fuel filter.

9. The fuel delivery system of claim 4, wherein the pressure regulating device is equipped with a pressure regulating mechanism, and the pressure regulating mechanism is at least one of a check ball valve, and an orifice.

10. The fuel delivery system of claim 8 further comprising:
a fuel tank,
wherein the pressure regulating device is positioned inside the fuel filter, and the fuel escape path of the pressure regulation device is configured to direct fuel in a lower portion of the fuel filter back to the fuel tank.

11. The fuel delivery system of claim 4, wherein the pressure regulating device is positioned upstream of the pressure drop device.

12. The fuel delivery system of claim 4, further comprising:
an engine fuel pump;
wherein the pressure drop device is positioned upstream of the engine fuel pump.

13. A fuel regulation device for a fuel delivery system comprising:
a fuel delivery path; and
a fuel escape path;
wherein the fuel delivery path and the fuel escape path are in fluid communication, the fuel escape path is configured to open when a fuel pressure in the fuel delivery path is at or above a predetermined pressure, the fuel escape path is configured to be closed when a fuel pressure in the fuel delivery path is below the predetermined pressure,

14. The fuel regulation device of claim 13, wherein the fuel escape path is configured to direct the fuel toward a fuel tank and the fuel delivery path is configured to deliver fuel to an engine.

15. The fuel regulation device of claim 13, wherein the fuel escape path includes at least one of a check valve, and an orifice.
